(19) United States
(12) Patent Application Publication
(10) Pub. No.: US 2024/0233314 A1
(43) Pub. Date: Jul. 11, 2024

(54) GRADIENT SPLIT SYSTEM FOR RICH HUMAN ANALYSIS

(71) Applicant: NEC Laboratories America, Inc., Princeton, NJ (US)

(72) Inventors: Yumin Suh, Santa Clara, CA (US); Weijian Deng, Turner (AU); Xiang Yu, Mountain View, CA (US); Masoud Faraki, Redwood City, CA (US); Manmohan Chandraker, Santa Clara, CA (US); Turgun Kashgari, Brentwood, CA (US)

(21) Appl. No.: 18/612,606

(22) Filed: Mar. 21, 2024

Related U.S. Application Data
(63) Continuation-in-part of application No. 17/496,214, filed on Oct. 7, 2021.
(60) Provisional application No. 63/094,365, filed on Oct. 21, 2020.
(60) Provisional application No. 63/111,662, filed on Nov. 10, 2020.
(60) Provisional application No. 63/113,944, filed on Nov. 15, 2020.

(51) Int. Cl. G06V 10/44; G06Q 30/0601; G06T 7/11; G06T 7/73; G06V 20/52; G06V 40/10; G06V 40/20; G08B 25/00; G08G 1/005; G08G 1/07

(52) U.S. Cl. CPC G06V 10/454; G06Q 30/0631; G06T 7/11; G06T 7/73; G06V 20/52; G06V 40/103; G06V 40/23; G08B 25/00; G08G 1/005; G08G 1/07

(57) ABSTRACT

A system for rich human analysis includes a memory and one or more processors in communication with the memory configured to extract images from camera in a surveillance system and feed the images to a person detection and tracking system that deciphers human activity tasks. Attributes of persons detected and tracked by the person detection and tracking system are estimated by a rich human analysis system to identify attributes in accordance with set criteria using a set of filters of deeper layers of convolutional layers of a feature extractor where the filters are divided into N groups trained on N corresponding tasks corresponding to task-specific heads such that one task is assigned to each group of the N groups and that each task loss updates only one subset of filters. One or more people that satisfy the attributes and the set criteria are identified.

### RELATED APPLICATION INFORMATION

This application is a continuation-in-part of co-pending U.S. application Ser. No. 17/496,214, filed on Oct. 7, 2021, and claims priority to Provisional Application No. 63/094,365, filed on Oct. 21, 2020, Provisional Application No. 63/111,662, filed on Nov. 10, 2020, and Provisional Application No. 63/113,944, filed on Nov. 15, 2020, the contents of which are incorporated herein by reference in their entirety.

### BACKGROUND

### Technical Field

The present invention relates to multi-task learning and, more particularly, to multi-task learning via gradient split for rich human analysis.

### Description of the Related Art

Many real-world problems require a comprehensive understanding of humans in images. For example, a customized advertisement system that tracks people, uses re-identification across cameras, recognizes their basic information (e.g., gender and age), and analyzes their behavior using pose estimation for the best advertisement. In recent years, impressive progress has been made regarding various human-related tasks, including person re-identification, pedestrian detection, and human pose estimation. Meanwhile, many annotated datasets have been proposed for each of the individual tasks. However, most of them consider a single task, lacking the capability to jointly investigate the other problems.

### SUMMARY

A method for multi-task learning via gradient split for rich human analysis is presented. The method includes extracting images from training data having a plurality of datasets, each dataset associated with one task, feeding the training data into a neural network model including a feature extractor and task-specific heads, wherein the feature extractor has a feature extractor shared component and a feature extractor task-specific component, dividing filters of deeper layers of convolutional layers of the feature extractor into N groups, N being a number of tasks, assigning one task to each group of the N groups, and manipulating gradients so that each task loss updates only one subset of filters.

A non-transitory computer-readable storage medium comprising a computer-readable program for multi-task learning via gradient split for rich human analysis is presented. The computer-readable program when executed on a computer causes the computer to perform the steps of extracting images from training data having a plurality of datasets, each dataset associated with one task, feeding the training data into a neural network model including a feature extractor and task-specific heads, wherein the feature extractor has a feature extractor shared component and a feature extractor task-specific component, dividing filters of deeper layers of convolutional layers of the feature extractor into N groups, N being a number of tasks, assigning one task to each group of the N groups, and manipulating gradients so that each task loss updates only one subset of filters.

A system for multi-task learning via gradient split for rich human analysis is presented. The system includes a memory and one or more processors in communication with the memory configured to extract images from training data having a plurality of datasets, each dataset associated with one task, feed the training data into a neural network model including a feature extractor and task-specific heads, wherein the feature extractor has a feature extractor shared component and a feature extractor task-specific component, divide filters of deeper layers of convolutional layers of the feature extractor into N groups, N being a number of tasks, assign one task to each group of the N groups, and manipulate gradients so that each task loss updates only one subset of filters.

A system for rich human analysis includes a memory and one or more processors in communication with the memory configured to extract images from camera in a surveillance system and feed the images to a person detection and tracking system that deciphers human activity tasks. Attributes of persons detected and tracked by the person detection and tracking system are estimated by a rich human analysis system to identify attributes in accordance with set criteria using a set of filters of deeper layers of convolutional layers of a feature extractor where the filters are divided into N groups trained on N corresponding tasks corresponding to task-specific heads such that one task is assigned to each group of the N groups and that each task loss updates only one subset of filters. One or more people that satisfy the attributes and the set criteria are identified.

In some embodiments, the feature extractor can generate a feature map from the images and task-specific heads output task predictions based on the feature map. During training, each group of the N groups is only updated by its corresponding task gradients. During training, each task learns its features without interference from other tasks. The set of filters can be divided, during training, by backpropagation. The one or more human activity tasks can include re-identification of a person having a trajectory that passes two or more cameras and attribute identification of the attributes of that person, such that the re-identification of the person and the attribute identification are concurrently performed. The one or more human activity tasks can include pose estimation and attribute identification, and the pose estimation and the attribute identification are concurrently performed. An action device can be responsive to the rich human analysis system wherein the action device adjusts a duration of a stop light in accordance with a pedestrian. An action device can be responsive to the rich human analysis system wherein the action device alerts first responders in accordance with a pedestrian in need of assistance. The one or more human activity tasks can include body segmentation and attribute identification, wherein the body segmentation and the attribute identification are concurrently performed. A customized service system can be responsive to the rich human analysis system, wherein the customized service system recommends products based upon the body segmentation and the attribute identification.

A non-transitory computer-readable storage medium comprising a computer-readable program for rich human analysis, wherein the computer-readable program when executed on a computer causes the computer to extract images from camera in a surveillance system; feed the images to a person detection and tracking system that deciphers one or more human activity tasks; estimate attributes of persons detected and tracked by the person detection and tracking system by a rich human analysis system to identify attributes in accordance with set criteria using a set of filters of deeper layers of convolutional layers of a feature extractor where the set of filters are divided into N groups trained on N corresponding tasks corresponding to task-specific heads such that one task is assigned to each group of the N groups and that each task loss updates only one subset of filters; and identify one or more people that satisfy the attributes and the set criteria.

In some embodiments of the computer-readable program for rich human analysis, the feature extractor can generate a feature map from the images and task-specific heads output task predictions based on the feature map. During training, each group of the N groups is only updated by its corresponding task gradients. During training, each task learns its features without interference from other tasks. The set of filters can be divided, during training, by backpropagation. The one or more human activity tasks can include re-identification of a person having a trajectory that passes two or more cameras and attribute identification of the attributes of that person, such that the re-identification of the person and the attribute identification are concurrently performed. The one or more human activity tasks can include pose estimation and attribute identification, and the pose estimation and the attribute identification are concurrently performed. An action device can be responsive to the rich human analysis system wherein the action device adjusts a duration of a stop light in accordance with a pedestrian. An action device can be responsive to the rich human analysis system wherein the action device alerts first responders in accordance with a pedestrian in need of assistance. The one or more human activity tasks can include body segmentation and attribute identification, wherein the body segmentation and the attribute identification are concurrently performed. A customized service system can be responsive to the rich human analysis system, wherein the customized service system recommends products based upon the body segmentation and the attribute identification.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary human analysis pipeline;

FIG. 2 is a block/flow diagram of an exemplary human analysis pipeline including a training procedure using multiple datasets, in accordance with embodiments of the present invention;

FIG. 3 is a block/flow diagram of an exemplary model division process, in accordance with embodiments of the present invention;

FIG. 4 is a block/flow diagram of exemplary parameter and model updates of the training algorithm, in accordance with embodiments of the present invention;

FIG. 5 is a block/flow diagram of an exemplary GradSplit framework including a shared backbone and task-specific head modules, in accordance with embodiments of the present invention;

FIG. 6 is a block/flow diagram of an exemplary gradient tensor used in two-task training for GradSplit, in accordance with embodiments of the present invention;

FIG. 7 is a block/flow diagram of how GradSplit uniformly divides the weights and each task loss only influences one specific filter group, in accordance with embodiments of the present invention;

FIG. 8 is an exemplary practical application for multi-task learning via gradient split for rich human analysis, in accordance with embodiments of the present invention;

FIG. 9 is an exemplary processing system for multi-task learning via gradient split for rich human analysis, in accordance with embodiments of the present invention;

FIG. 10 is a block/flow diagram of an exemplary method for multi-task learning via gradient split for rich human analysis, in accordance with embodiments of the present invention;

FIG. 11 is a block/flow diagram of an exemplary surveillance system showing a graphical user interface for selected body attributers for training and inference for detecting and tracking people using rich human analysis, in accordance with embodiments of the present invention;

FIG. 12 is a block/flow diagram showing training a system model for additional data for rich human analysis, in accordance with embodiments of the present invention;

FIG. 13 is a block/flow diagram of an exemplary surveillance system showing a tracking and detection engine for detecting and tracking people using rich human analysis, in accordance with embodiments of the present invention;

FIG. 14 is a block/flow diagram of an exemplary assistance system showing tracking and detection of people using rich human analysis, in accordance with embodiments of the present invention; and

FIG. 15 is a block/flow diagram of an exemplary retail service system using rich human analysis, in accordance with embodiments of the present invention.

### DETAILED DESCRIPTION OF PREFERRED EMBODIMENTS

The exemplary embodiments introduce a unified framework that solves multiple human-related tasks simultaneously or concurrently, using datasets annotated each for an individual task. The desired framework utilizes the mutual information across tasks and saves memory and computation cost via a shared network architecture. However, critical gradient signals for one task can be harmful information for another, potentially generating gradient conflicts when learning a shared network. This introduces an optimization challenge and leads to sub-optimal overall performance. For example, pose estimation needs pose sensitive features, while person re-identification demands pose invariant features.

To address this issue, existing methods integrate task-specific modules into the shared backbone so that task-specific features can be generated. The shared network is encouraged to learn task-specific features for human tasks, but instead of using additional modules, the exemplary methods achieve this by using a carefully designed training scheme. Specifically, at each convolution module in the shared backbone, the exemplary methods split or divide the filters into N groups for N tasks. During training, each group is only updated by its corresponding task gradients. This is referred to as Gradient Split (or GradSplit) as it divides or splits gradients into groups during updates.

GradSplit only applies to filters during the back-propagation process, whereas the forward pass is the same as the baseline. This brings at least the following benefits. First, the task-specific filters can still use information from other tasks as they receive features produced from the other task-specific filters. In addition, the exemplary method does not introduce any additional parameter or computational cost. Finally, the exemplary method does not require comparison of gradients from all task losses, and, thus, simplifies the training procedure, especially for the case of dealing with multiple single annotation datasets. In another contribution, the exemplary methods provide a strong multi-task baseline by analyzing the normalization layers in the shared backbone. This effectively alleviates the domain gap issue when learning from multiple datasets.

The exemplary methods target at training a unified model that solves multiple human-related tasks simultaneously or concurrently.

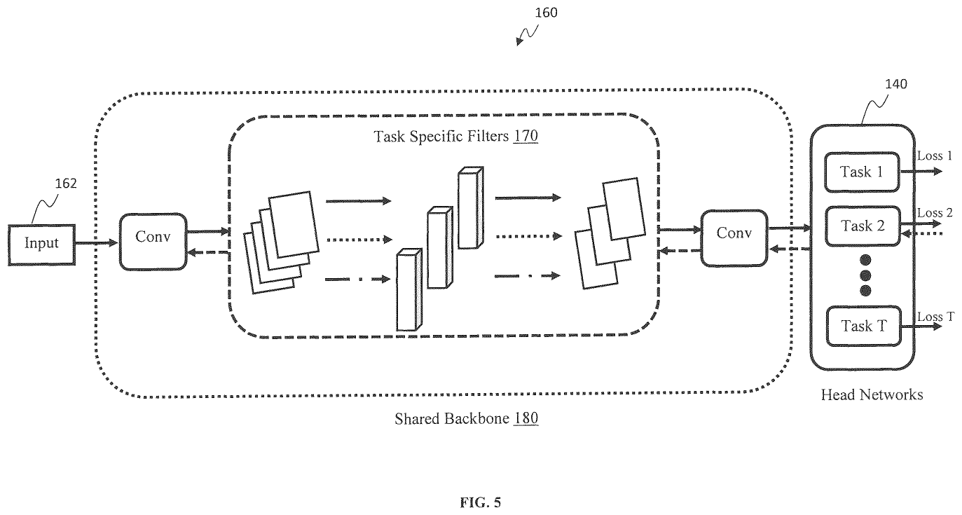

The exemplary methods seek optimal parameters Θ that minimize the joint task loss L:

$${min}_{Θ} L ( Θ ) = {\sum }_{t = 1}^{T} {λ}_{t} {L}_{t} ( Θ )$$

where T and Lₜ denote the number of tasks and task loss Lₜ, respectively. It is assumed that a multi-head network has one shared backbone and task-specific heads as illustrated in FIG. 5 described below.

A well-known issue for multi-task learning is that if the tasks have conflicts (e.g., identity-invariant feature versus identity-variant attributes), then joint optimization leads to sub-optimal solutions. To alleviate this, the exemplary methods propose a training scheme dubbed Gradient Split (or GradSplit) that enables each task to learn its essential features without interference from other tasks. Instead of using each task loss to update all filters of convolution in the shared backbone, GradSplit explicitly makes it only impact a subset of the filters.

Regarding the gradient split, consider a convolution with cᵢ input channels and cₒ output channels, parameterized by θ∈ [symbol] ^{hxwxc}^{ᵢ}^{xc}^{ₒ}. It contains cₒ filters and each filter produces one feature map, where h and w indicate height and width, respectively. Based on the previous equation, the standard stochastic gradient descent is formulated as:

$$θ ← θ - α {\sum }_{t} {∇}_{θ} {L}_{t}$$

Since GradSplit averages gradients from different tasks, GradSplit may cancel out useful signals if the tasks conflict, and, thus, potentially degrade the performance.

The exemplary methods split gradients across tasks and apply them to different filters so that there is no gradient conflict. Given T tasks, the exemplary methods divide filters into T groups and assign each group explicitly to one task. The exemplary methods denote the parameters assigned to the t^{th} task as θ∈ [symbol] ^{hxwxc}^{ᵢ}^{xn}^{ₜ}, where nₜ is the number of output channels assigned to the task t. Then, one iteration of parameter update using GradSplit is formulated as:

θₜ→θₜ−α∇_{θ}_{ₜ}^{GS}L, where ∇_{θ}_{ₜ}^{GS}L=∇_{θ}_{ₜ}Lₜ

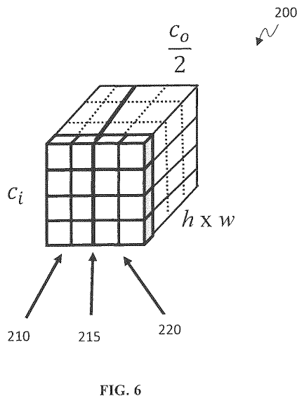

Therefore, GradSplit updates parameter θₜ using the gradients from its assigned task only while discarding gradients from the other tasks. In the update, one task does not interfere with another because gradients are not averaged over tasks. FIG. 6 described below illustrates the gradients used for GradSplit.

GradSplit does not influence the forwarding procedure while affecting only the gradient updating procedure. As a result, GradSplit is easily applicable to any convolution layers without modifying the network structure. The exemplary methods apply GradSplit to the last layer (e.g., Layer4 of ResNet-50) of the shared backbone, which empirically leads to the best performance. For each module, the exemplary methods adopt a simple strategy to evenly divide its filters into T groups where each group contains [cₒ/T] filters.

Regarding intuitive understanding of GradSplit as regularization, consider manipulating gradients with respect to θₜ as a weighted linear sum of task gradients:

$$\text{?} {L}_{t} + \text{?}$$

$$\text{?} \text{indicates text missing or illegible when filed}$$

When mₜ=1 and m_{t′}=0 (t≠t′), the above equation becomes ∇_{θ}_{ₜ}^{GS}L. When mₜ is a probabilistic binary mask, it is equivalent to dropping-out gradients. It injects noise to gradients during training, so it makes a regularization effect. The operation turns out to be equivalent to GradDrop with specifically designed dropout masks when the drop rate p∈[0, 1).

Regarding training with multiple task-specific datasets, a practical setting is assumed where each dataset includes annotations for a single task. Under this condition, a model is trained using multiple datasets whose images from different datasets present unique visual characteristics for background, lighting, camera views, and resolutions.

$${min}_{Θ} L ( Θ ) = {\sum }_{t = 1}^{T} {λ}_{t} {L}_{t} ( Θ )$$

is further specified as:

$${min}_{Θ} {\sum }_{t = 1}^{T} {λ}_{t} \text{?} [ \text{?} ( {f}_{Θ} ( {X}_{t} ) , {Y}_{t} ) ]$$

$$\text{?} \text{indicates text missing or illegible when filed}$$

where [symbol] and f_{Θ} denote task t loss function and prediction function, respectively.

The exemplary methods adopt a round-robin batch-level update regime for optimization. One multi-task iteration includes a sequence of each task batch forwarding and parameter updating. It is flexible enough to allow different input sizes for different tasks and also scales to the number of tasks with constrained graphical processing unit (GPU) memory. This is beneficial when training with certain loss functions where batch sizes affect the performance, e.g., triplet loss.

Regarding domain gaps between training datasets, with round-robin batch construction, mini-batch for task t includes images sampled from the distribution Dr.

The empirical loss is computed as:

$${\sum }_{t = 1}^{T} \text{?} \frac{1}{\text{?}} \text{?} ( {f}_{Θ} ( {x}_{t} ) , {y}_{t} )$$

$$\text{?} \text{indicates text missing or illegible when filed}$$

where [symbol] ₜ denotes a mini-batch sampled for task t. Meanwhile, batch normalization (BN) is widely adopted to state-of-the-art network architectures such as EfficientNet and ResNet. It is noted that BN uses running batch statistics during training and the accumulated statistics during inference, with independent and identically distributed (i.i.d) mini-batch assumptions. Due to domain gaps between datasets, running BN statistics used to compute task t loss for mini-batch [symbol] ₜ follows different distributions across tasks during training, whereas common BN statistics are accumulated over tasks and used in the testing stage. It is found that such BN statistics mismatch between training and testing stage degrades the performance significantly.

As one candidate solution, task-specific BN mitigates this issue by using separate BN modules for different tasks while sharing the remaining convolution parameters. However, features following the first task-specific BN cannot be shared across tasks and require N forward passes for N tasks, which increases the computation cost. Another solution is to fix BN statistics during training, however, this also degrades the baseline performance. Instead, the exemplary methods use group normalization (GN) in the shared backbone, which can circumvent the above issue, yielding solid baselines.

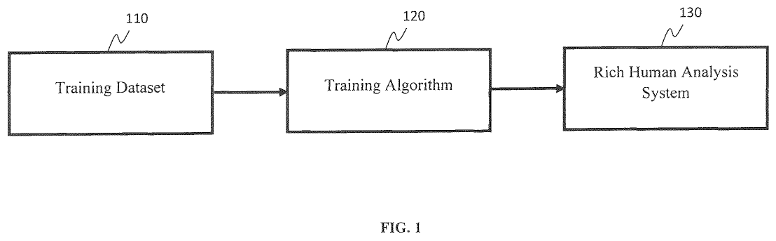

FIG. 1 is a block/flow diagram of an exemplary human analysis pipeline.

Training images 110 are used as input to a training algorithm 120 that updates the parameters of the human analysis system based on the input training data. After training, the human analysis system 130 can be used on unseen images.

Regarding the training dataset(s) 110, training data for the human analysis system includes a set of images, along with annotations for the tasks of interest. The form of annotation differs depending on tasks. For example, each person image is annotated with the identity of the person for the person re-identification task. For the pose estimation task, the key points annotations are given for each image. Annotation for one key body joint includes two values, coordinates in the image space and its visibility. Each annotation for one image includes annotations for the key body joints such as, e.g., shoulders, elbows, and wrists.

Regarding the training algorithm 120, the model is a deep neural network which has parameters that need to be adjusted based on the given training data. A loss function is defined so that the difference between ground truth and the current model's predictions is measured for a given image of the training data. Then, the model parameters can be updated in a direction that reduces the loss using optimization techniques, such as stochastic gradient descent (SGD).

Regarding the rich human analysis model/system 130, after adjusting the parameters of the neural network model using the training data 110, the system is ready to be applied on new images. For a given image, the rich human analysis system 130 returns outputs for all the tasks simultaneously or concurrently.

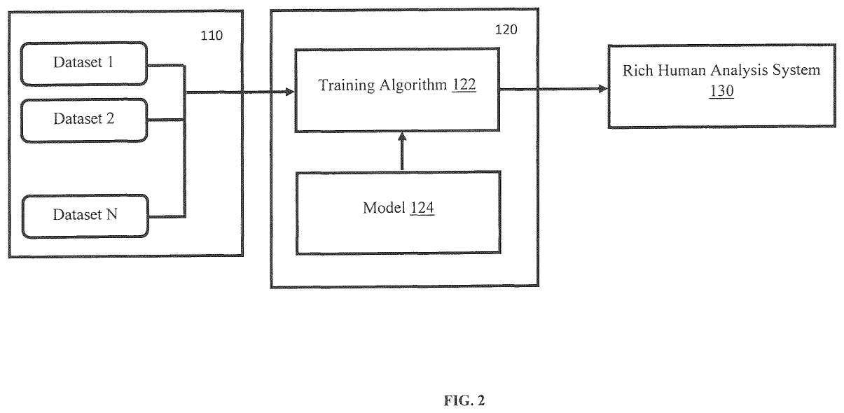

FIG. 2 is a block/flow diagram of an exemplary human analysis pipeline including a training procedure using multiple datasets, in accordance with embodiments of the present invention.

The pipeline of FIG. 2 differs from the standard pipeline of FIG. 1 for human analysis in two respects. First, the training data 110 includes N datasets, one for each task. One dataset includes images together with their annotation on the task. For example, dataset 1 includes person images with their annotated identities and dataset 2 includes person images with the annotations for key body joints locations. Second, the model is trained to perform multiple tasks simultaneously or concurrently. To address the potential conflict among tasks, the exemplary methods divide the model into task-specific and shared parts, that is model 124 and altered training algorithm 122.

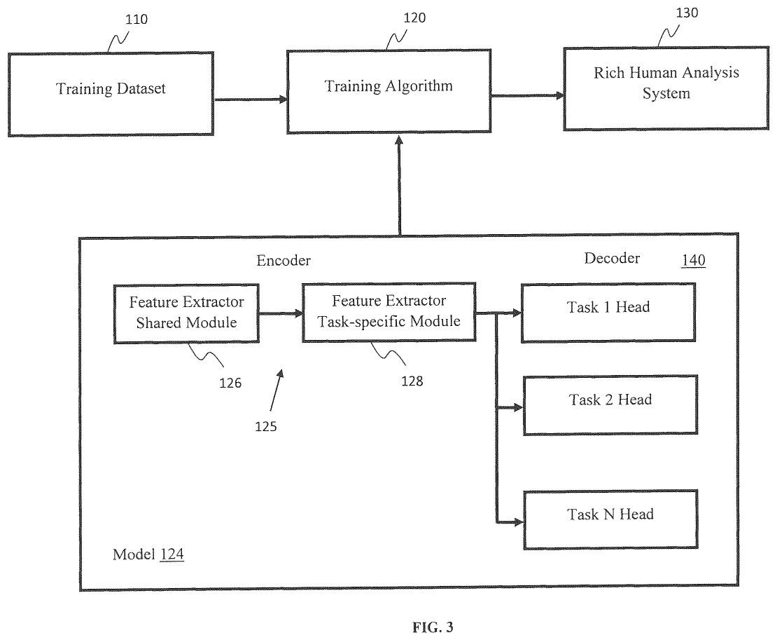

FIG. 3 is a block/flow diagram of an exemplary model division process, in accordance with embodiments of the present invention.

The model includes two parts, that is, feature extractor 125 and task-specific heads 140. Feature extractor 125 generates a feature map from a given image and task-specific heads 140 output the task predictions based on the feature map. The exemplary methods further divide the feature extractor 125 into shared module (or component) 126 and task-specific module (or component) 128. For each layer in the task-specific module 128, the filters are divided into N groups and each group is assigned to one task. This assignment specifies the expertise of each filter so that the training algorithm 120 updates the parameter in a way that reinforces these expertise. Feature extractors 125 are trained using all the datasets and task-specific heads 140 are trained using the corresponding task dataset.

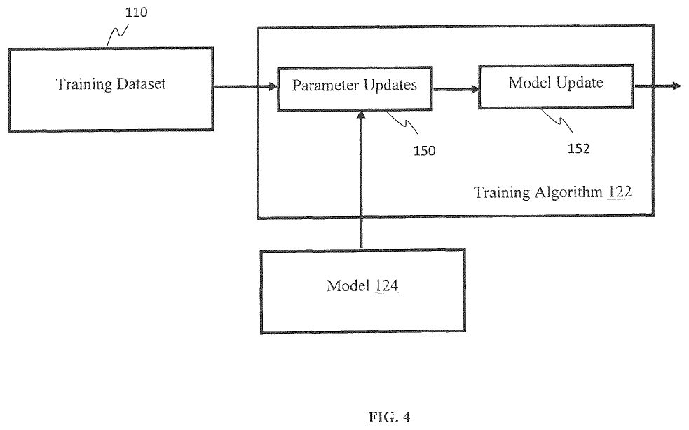

FIG. 4 is a block/flow diagram of exemplary parameter and model updates of the training algorithm, in accordance with embodiments of the present invention.

During training, the exemplary methods modify the parameter updates 150 based on the model division 124 to get model updates 152. In the conventional training algorithm, every parameter is updated in a direction to minimize the sum of all task losses. The same update procedure is maintained as the conventional algorithm for every parameter except for the ones in the task-specific modules of the feature extractor defined in 124. The parameters in the task-specific modules are updated to minimize the loss of its assigned task only, instead of minimizing the sum of all task losses.

FIG. 5 is a block/flow diagram of an exemplary GradSplit framework 160 including a shared backbone 180 and task-specific head modules 140, in accordance with embodiments of the present invention.

The exemplary embodiments of the present invention aim at visual human analysis, which is the task of recognizing various attributes of a person in a given RGB image. Human pose estimation is one example of human analysis. A human pose estimation system takes an image as input and predicts the pose of person in the image, which is represented as the locations of key body joints such as head, shoulder, etc. Rich human analysis extends this example to diverse tasks beyond human pose estimation, such as identity, gender, and age recognition. To train a human analysis system, a sufficient amount of training data is required for each of the tasks that system should solve.

A deep neural network is a system including sequential layers where each layer takes an output feature map of the previous layer as input and outputs a feature map. The output of each layer, or a feature map, is a 3-dimensional tensor which includes several matrices where each matrix represents a certain characteristic present around each location. For example, the first layer of a pose estimation system takes an RGB image as input and outputs a feature map that encodes visual information of low abstract level, such as the edge, color, and texture. A deeper layer outputs a feature map that encodes information of higher abstract level, such as the presence of body parts at each location. Each layer includes multiple filters where one filter takes the feature map from the previous layer as its input and outputs a 2-dimensional matrix. These matrices from all the filters in that layer are concatenated to the output feature map.

To perform several human-related tasks simultaneously on one image, the conventional system requires increased computation cost and memory, proportional to the number of tasks. For example, when a system needs to identify people and recognize their pose at the same time, conventional methods employ two separate systems, one for identifying people and the other for predicting poses. This approach not only increases the required computation and memory cost but also cannot leverage useful information obtainable from other tasks.

In contrast, the exemplary method introduces the network of FIG. 5 which includes a shared backbone 180 and task-specific head modules 140. To alleviate the gradient conflict issue, GradSplit manipulates gradients so that each task loss updates one group of filters only, yielding task-specific filters 170. Note that only the backward flow is altered whereas the forward flow remains the same. The gradients from input 162 are used to update its corresponding filters only. In this way, the other task losses do not introduce conflicting gradients.

Therefore, the exemplary approach of FIG. 5 mitigates the trade-off between computation cost and performance. The exemplary approach can predict rich information of a person given a RGB image with similar computation cost to each single task system while achieving comparable or better performance. The exemplary approach further exploits the useful information across tasks by sharing the common feature extractor.

As one example, consider an airport surveillance system that can identify people for automated check-in. A person may want to add a new function to the system that checks if a person is wearing a mask or not to prevent the spread of infectious diseases. In addition, a person may want to optimize the service by understanding the distribution of gender and age of the passengers. Similar as in the scenario above, one would need to employ multiple systems, one for each task. The exemplary approach of FIG. 5 allows the use of a unified system that can perform multiple tasks at the same time effectively and efficiently.

FIG. 6 is a block/flow diagram of an exemplary gradient tensor 200 used in two-task training for GradSplit, in accordance with embodiments of the present invention.

A visual example of a gradient tensor 200 used in the two-task training for stochastic gradient descent of GradSplit is shown. A convolution includes cᵢ input channels and cₒ output channels, e.g., θ∈ [symbol] ^{hxwxc}^{ᵢ}^{xc}^{ₒ}. With GradSplit, task loss Lₜ is used to compute the gradient tensors of the corresponding filters only. The GradSplit includes a division or split line 215 that separates the left-hand side (e.g., Task A) 210 from the right-hand side (e.g., Task B) 220.

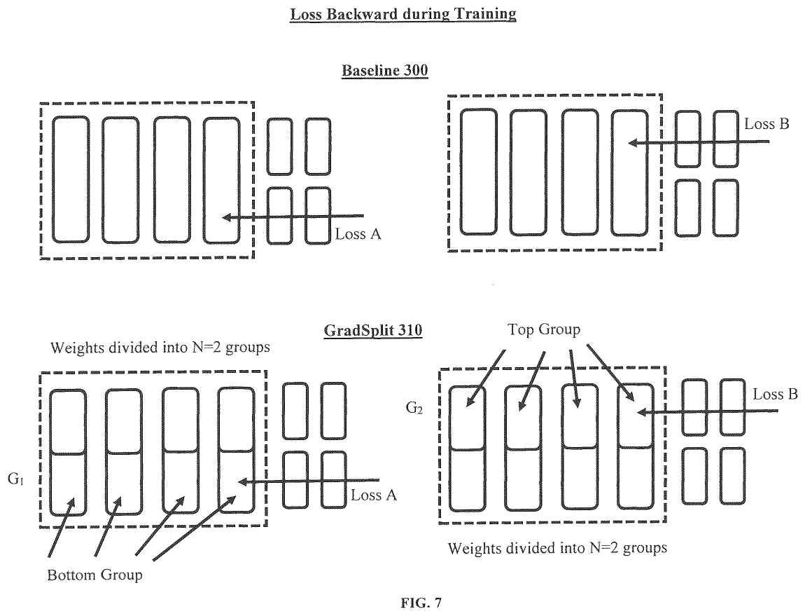

FIG. 7 is a block/flow diagram of how GradSplit uniformly divides the weights and each task loss only influences one specific filter group, in accordance with embodiments of the present invention.

During back-propagation, in the baseline model 300, each task loss is used to update all weights. As a result, Task A and Task B can have a conflict, where there is a confusion in shared weights.

During back-propagation, in the GradSplit model 310, the exemplary methods uniformly divide the weights into N=2 groups. Thus, each task loss only influences one specific filter group. The first filter group, G₁, includes the bottom weights or bottom group only (horizontally aligned with designation G₁), whereas the second filter group, G₂, includes the top weights of top group only (horizontally aligned with designation G₂).

In conclusion, the exemplary embodiments of the present invention mitigate the conflict problem with a carefully designed optimization method. The exemplary embodiments assume a model that includes an encoder and a decoder. The encoder is the feature extractor 125 that shares its output across all the tasks. The decoder includes task-specific heads 140 that take the output of the feature extractor 125 as their input and predict task-specific results.

First, the exemplary methods divide the filters of the last or deepest layers of the convolutional layers of the feature extractor 125 into N groups and assign one task to each group. Here, N is the number of tasks.

Second, the exemplary methods train the network by updating the whole parameters to minimize the overall losses of N tasks while updating the parameters (150; FIG. 4) in each group to minimize the loss of the assigned task only.

To better understand the training procedure, consider a system that has 10 filters in the last or deepest layer of the feature extractor when the tasks are A and B. A conventional training algorithm updates 10 filters to minimize the sum of losses of tasks A and B. The exemplary method, however, updates the first 5 filters to minimize the loss of task A and updates the remaining 5 filters to minimize the task B loss. This makes the first 5 filters to predict the features specifically required for task A. It is noted that these filters take features for both task A and B from the previous layer, as their inputs. This training algorithm circumvents the potential conflict between tasks by explicitly guiding each filter to learn features specific to its assigned task. At the same time, it enables the system to exploit useful features across tasks. The computation cost and memory required by the proposed system is same as the conventional multi-head network and N times smaller than a system including multiple single-task models.

Therefore, the exemplary embodiments present an approach to train a unified deep network that simultaneously or concurrently solves multiple human-related tasks such as person re-identification, pose estimation and attribute prediction. Such a framework is desirable since information across tasks may be leveraged with restricted computational resources. However, gradient updates from competing tasks can conflict with each other, making the optimization of shared parameters difficult and leading to sub-optimal performance. The exemplary embodiments introduce a training scheme referred to as GradSplit that effectively alleviates such issues. At each convolution module, GradSplit splits or divides features into N groups for N tasks and trains each group using gradient updates from the corresponding task only. During training, the exemplary methods apply GradSplit to a series of convolutions. As a result, each module or component is trained to generate a set of task-specific features using the shared feature from the previous module. This enables the network to leverage complementary information across tasks while circumventing gradient conflicts.

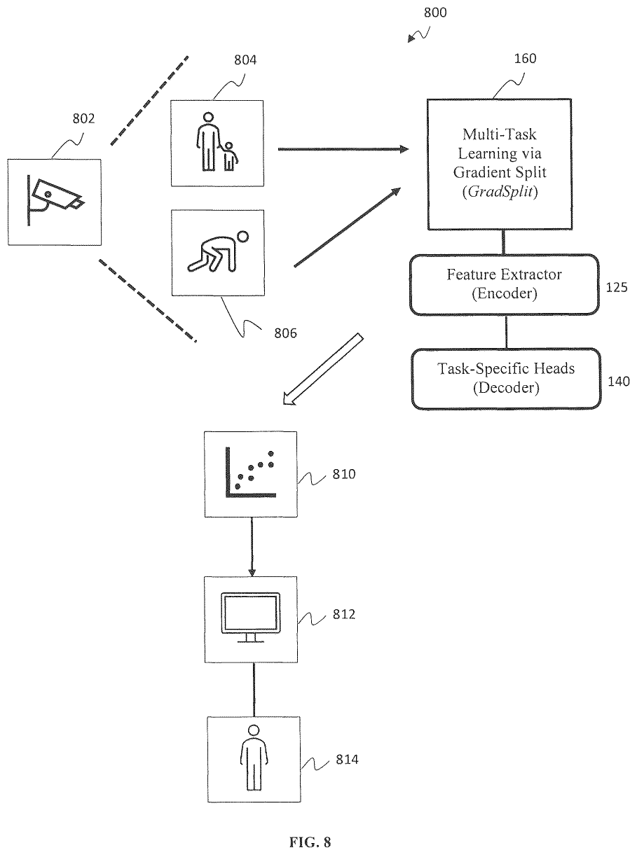

FIG. 8 is a block/flow diagram 800 of a practical application for multi-task learning via gradient split for rich human analysis, in accordance with embodiments of the present invention.

In one practical example, a camera 802 can detect objects or people 804, 806 in different poses, with different genders. The exemplary methods employ the multi-task learning via gradient split 160 using a feature extractor 125 and task-specific heads 140. The results 810 (e.g., poses) can be provided or displayed on a user interface 812 handled by a user 814.

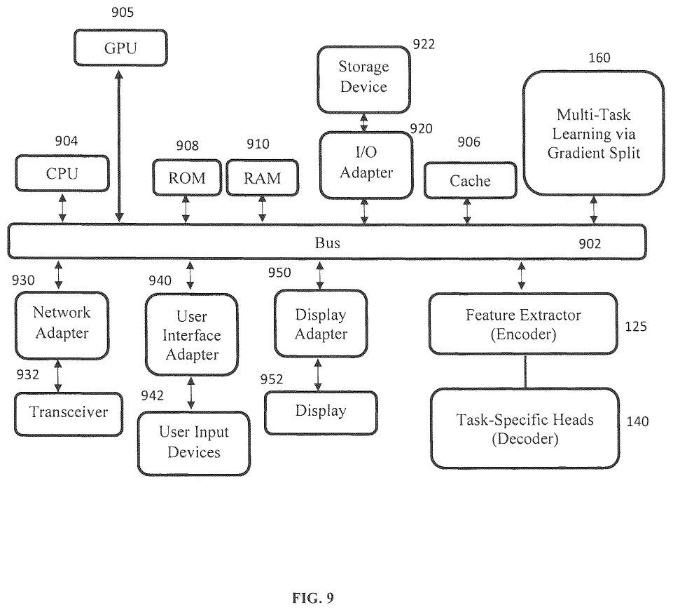

FIG. 9 is an exemplary processing system for multi-task learning via gradient split for rich human analysis, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the multi-task learning via gradient split 160 can be employed by using a feature extractor 125 and task-specific heads 140.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

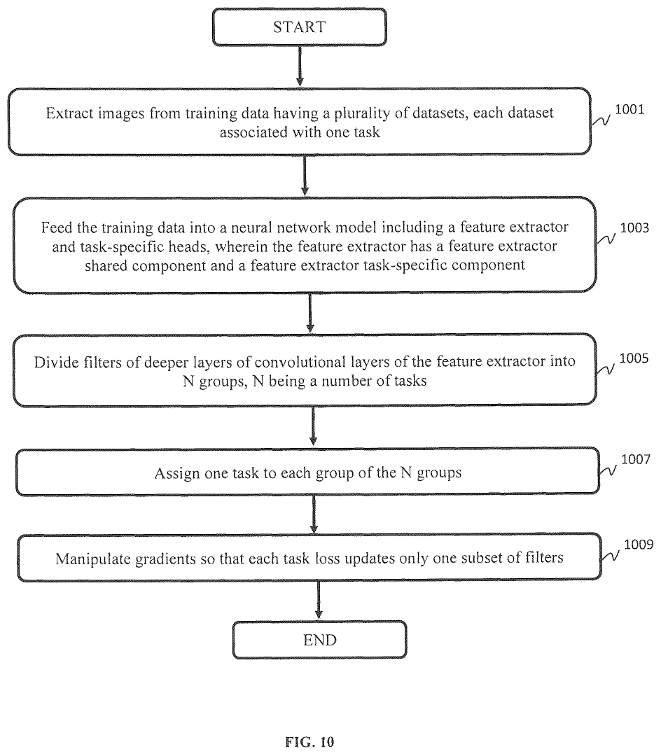

FIG. 10 is a block/flow diagram of an exemplary method for multi-task learning via gradient split for rich human analysis, in accordance with embodiments of the present invention.

At block 1001, extract images from training data having a plurality of datasets, each dataset associated with one task.

At block 1003, feed the training data into a neural network model including a feature extractor and task-specific heads, wherein the feature extractor has a feature extractor shared component and a feature extractor task-specific component.

At block 1005, divide filters of deeper layers of convolutional layers of the feature extractor into N groups, N being a number of tasks.

At block 1007, assign one task to each group of the N groups.

At block 1009, manipulate gradients so that each task loss updates only one subset of filters.

Other embodiments including practical applications for multi-task learning via gradient split for rich human analysis will now be described in accordance with the present invention. A search can be performed by using body or image attributes. As before, exemplary embodiments include a shared backbone and task-specific head modules. To alleviate the gradient conflict issue, gradients are manipulated so that each task loss updates one group of filters only, yielding task-specific filters. Note that only the backward flow is altered whereas the forward flow remains the same. The gradients from an input are used to update its corresponding filters only. In this way, the other task losses do not introduce conflicting gradients. A trade-off between computation cost and performance can be balanced.

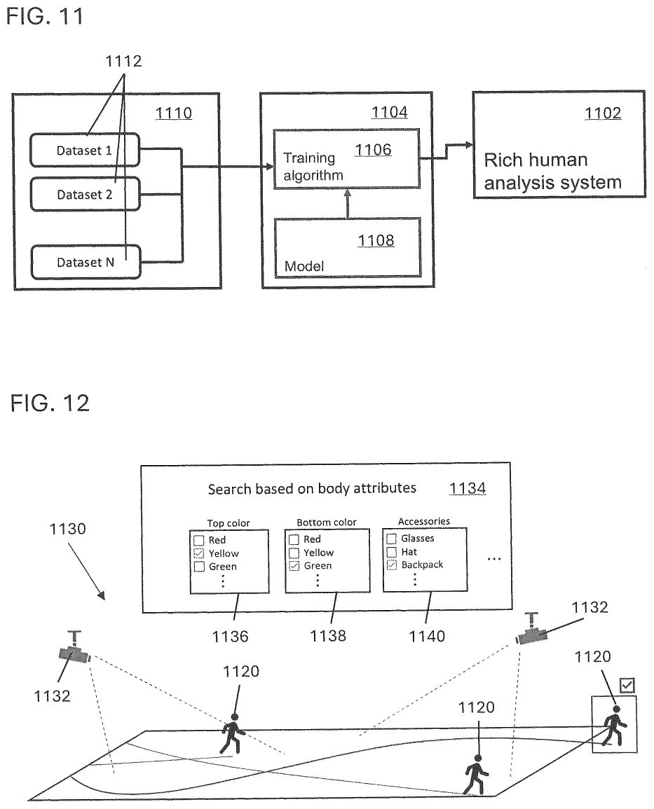

Referring to FIGS. 11, a rich human analysis system 1102 (or simply rich analysis system) trained to predict rich information of a person or person given a RGB image with similar computation cost to each single task system while achieving comparable or better performance is shown. The exemplary approach further exploits the useful information across tasks by sharing a common feature extractor.

Referring to FIG. 12 with continued reference to FIG. 11, a surveillance system 1130 can be employed to train models 1108 to permit a search based on body-related attributes, including body type, clothing worn, colors, textures, etc. Any number of attributes can be included and trained into the rich analysis system 1102. Attributes can be introduced using data sets 1112 (datasets 1-N), based on the type and number of attributes to be trained by a training system 1104. The datasets 1112 can be trained using the surveillance system 1130 or can be trained using other available datasets. The training system 1104 includes a model 1108 or models that are trained using a training algorithm 1106 that employs the gradient split methods described herein. Additional training data (datasets 1-N) are needed to finetune the models 1108 for targeted surveillance scenarios (e.g., location, lighting conditions, day/night, indoor/outdoor, targeted age ranges, apparel worn, height, weight, etc.).

The surveillance system 1130 can include sensors such as cameras 1132 to monitor and track activity. The activity can include people 1120 passing in front of a business, on a line at a business, at a security checkpoint, etc. An interface 1134 is preferably programmed in software and displayed on a display (e.g., display 952, FIG. 9) to permit a user to interact with and program surveillance criteria into the surveillance system 1130.

After training, the interface 1134, which can include a graphical user interface (GUI), can include easily selectable criteria that reflects the capability of the surveillance system 1130. For example, the capabilities (e.g., tasks) will correspond with the training in data sets 1112. In the example shown, the illustrative capabilities include body attributes 1136, 1138, 1140, etc. These, respectively include, e.g., a top color (jacket, shirt, etc.), a bottom color (pants, boots, etc.), accessories (glasses, hat, backpack, etc.). Body attributes 1136, 1138, 1140, etc. can be user-selected by ticking boxes, although other input types can be selected.

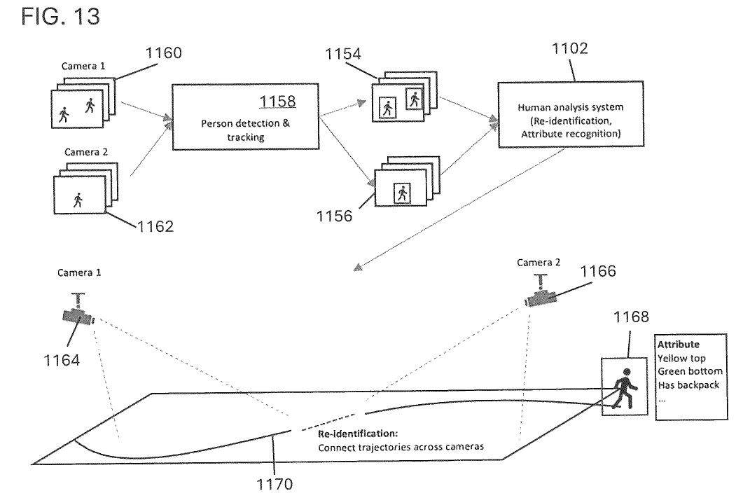

Referring to FIG. 13, a detection and tracking engine (or system) 1158 is employed to detect and track people between cameras. The trained human analysis system 1108 takes persons detected from the detection and tracking engine 1158 as input to identify the person or persons that meet the selected criteria e.g., criteria selected at interface 1134. The trained human analysis system 1108 estimates attributes of persons detected and tracked by the person detection and tracking engine or system 1158 to identify attributes in accordance with set criteria using a set of filters of deeper layers of convolutional layers of a feature extractor where the filters are divided into N groups trained on N corresponding tasks corresponding to task-specific heads such that one task is assigned to each group of the N groups and that each task loss updates only one subset of filters.

The detection and tracking engine 1158 takes as input camera images 1160, 1162 taken from one or more cameras 1164, 1166. The images 1160, 1162 are fed into the person detection and tracking engine 1158 which deciphers one or more human activity tasks. Since the cameras 1164, 1166 are located in different positions, tracking of people is needed so that a person identified on one camera can be re-identified when another camera is reached. In this way, a full trajectory 1170 can be deciphered for each individual.

In accordance with an embodiment, the detection and tracking engine 1158 can re-identify people between cameras 1164, 1166 (determine trajectories). Prior solutions would require separate engines for attribute recognition and re-identification. Since embodiments of the present invention are computationally efficient both attribute recognition and re-identification are available from a unified engine, e.g., the detection and tracking engine 1158, which can include the rich human analysis system 1102. Re-identification information 1154 from human activities and recognized attribute information 1156 for these humans can be concurrently input to the rich analysis system 1102 to identify a person or persons 1168 that meet the selected criteria. This implementation can be employed to search for suspects in police applications, find missing persons, track people at intersections, etc. The human activities can be classified as tasks and can include, e.g., re-identification of a person having a trajectory that passes two or more cameras. Attribute identification of the attributes of that person can also be considered a task. These tasks can be concurrently performed.

In another embodiment, the system 1130 can be employed for airport check-in services to reduce complexity for passenger boarding. The system 1130 includes camera based automation for luggage at check-in, which predicts a total amount of luggage and enables better management of in-flight storage. This prevents delays caused by insufficient overhead space. Passenger identification and tracking throughout the airport for effective boarding gate control are also provided by counting the passengers and recognizing absent individuals to optimize the boarding process.

Detection and tracking engine 1158 is employed to detect and track people between cameras in an airport. The trained human analysis system 1108 takes persons detected from the detection and tracking engine 1158 as input to identify the person or persons. The detection and tracking engine 1158 takes as input camera images 1160, 1162 taken from one or more cameras 1164, 1166. Since the cameras 1164 and 1166 are located in different positions, tracking of people is also needed so that a person identified on one camera can be re-identified when another camera is reached. In this way, passengers can be tracked throughout the airport prior to boarding.

In accordance with an embodiment, the detection and tracking engine 1158 can re-identify people between cameras 1164, 1166 (determine trajectories) and recognize attributes using the rich human analysis system 1102, such as luggage to be stowed. Prior solutions would require separate engines for attribute recognition and re-identification tasks. Since embodiments of the present invention are computationally efficient both attribute recognition and re-identification are available from a unified engine. Re-identification information 1154 and recognized attribute information 1156 are concurrently input to the rich analysis system 1102 to identify the passengers 1168 on a particular flight.

Additional training data is needed to finetune the models for airport conditions and cameras (e.g., camera resolution, specific lighting conditions in the airport, camera view and angles depending on the camera installation settings). This training can be performed as described in accordance with FIG. 11. Detection and tracking system 1158 identifies and counts passengers in the airport. After identifying each person at check-in, the system 1130 can track the person in the airport until boarding using re-identification from the human analysis system 1102.

Luggage detection and size estimation can be done based on a relative comparison between the luggage size (e.g., length) and a person's height where the person height can be estimated based on key points estimation (e.g., pose estimation) or annotations (e.g., preference information) from the human analysis system 1102.

Compared to traditional methods of manual boarding and luggage management, the unified system offers improvements in efficiency and passenger experience. The system 1130 optimizes in-flight storage and reduces the risk of delays or lost luggage. It can also minimize wait times and reduce passenger effort. The implementation based on prior solutions requires, e.g., separate engines for re-identification and pose estimation.

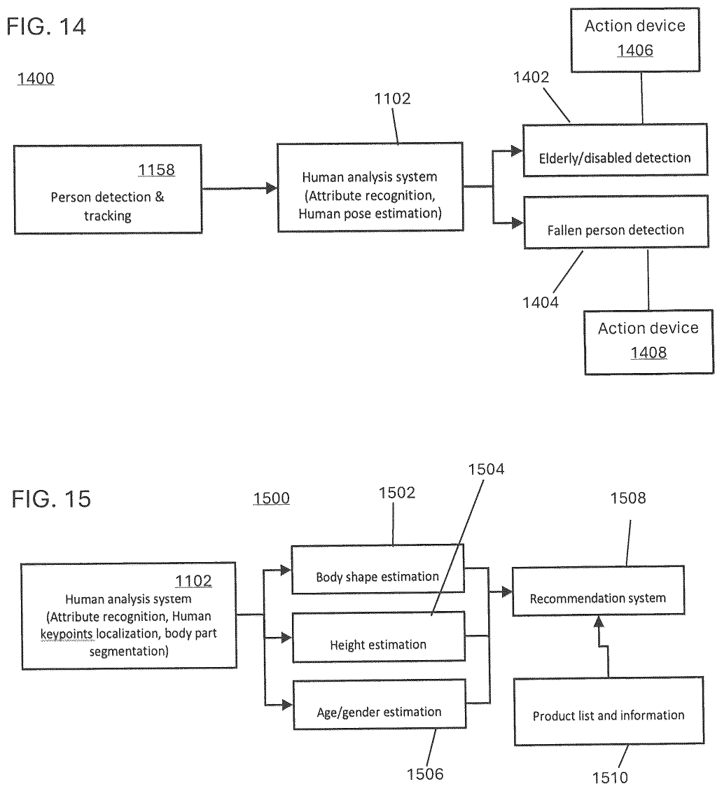

Referring to FIG. 14, in other embodiments, a human assistance system 1400 can be employed to identify individuals in need of assistance (e.g., emergency medical care, police, etc.). In another embodiment, the human assistance system 1300 can be employed for home care for the elderly, disabled or other applications. By detecting and adapting to the needs of the elderly and disabled, the system 1300 can help reduce the risk of accidents both in home or outside the home (e.g., crossing the street safely).

In one embodiment, the system 1400 can take action using an action device 1406, 1408 to provide assistance to individuals. In one example, the system 1400 can monitor an intersection, e.g., using a camera and the detection and tracking engine 1158, and a traffic light can have its duration modified by the action device 1406 based on the needs of the pedestrian, for example, to ensure that the pedestrian has sufficient time to cross the street safely, regardless of their mobility limitations. By providing customized assistance to pedestrians, the system 1400 can also help reduce the risk of accidents and ensure that everyone can navigate the intersection safely. The action devices 1406, 1408 can include a circuit, software devices, sensors, a software program or any other device of mechanism that can fulfill the activities needed in accordance with the determinations of the system 1400, e.g., delay the stop light.

The system 1400 can also be configured to detect fallen individuals at intersections and request necessary aid. By detecting and responding to these incidents quickly, the system 1400 can help reduce the risk of further injury and ensure that appropriate medical attention is provided promptly.

The system 1400 is additionally trained using training data to finetune models for the targeted surveillance scenarios (e.g., location, day/night, etc.) as described with respect to FIG. 11. The detection and tracking engine 1158 detects and tracks people as needed. The human analysis system 1102 takes persons detected from the engine 1158 as input.

The human analysis system 1102 can identify individuals that need assistance. This can include identifying human activity tasks, such as pose estimation, and identifying attributes, e.g., walking apparatus, wheelchair, elderly or disabled features, a prone pose of a fallen individual, etc., which can be concurrently performed.

Once an individual in need of assistance is detected in block 1402, corresponding action 1406 can be taken, e.g., increased duration of a stop light, etc. Detection based on the estimated attributes is gathered from the rich human analysis system 1102.

In another application, fallen person detection 1404 can be determined based on the estimated human pose detection. Attributes can be concurrently determined from the rich human analysis system 1102. If a fallen person is detected, an action of an action device 1408 can include calling an ambulance, police or other first responders, as needed.

The human assistance system 1400 at intersections prioritizes the safety of vulnerable road users, such as the elderly and disabled, by considering their unique needs. Unlike traditional traffic sign control, which provides a fixed amount of time for crossing the street, this system can adapt to the needs of pedestrians. Governments can use this implementation to enhance safety at traffic intersections.

Referring to FIG. 15, in another embodiment, a customized service system 1500 for retail stores utilizes rich human analysis to provide personalized recommendations. This can potentially improve the customer experience and increase sales for retailers. By identifying and analyzing key human attributes, such as age range, gender, and body shape, the system 1500 can provide personalized recommendations of relevant products that match the customer's needs and preferences.

As before, additional training data is necessary to finetune models for the targeted scenarios (e.g., indoor, targeted age ranges, etc.) as described with reference to FIG. 11. In accordance with one embodiment, body shape estimation is performed in block 1502 based on body part segmentation using the rich human analysis system 1102. Height estimation can also be determined in block 1504 based on human key points estimation of the rich human analysis system 1102. Age and gender estimation in block 1506 can also be performed based on estimated attributes of the rich human analysis system 1102. Other attributes can be employed instead of or in addition to those illustratively described.

Based upon estimation from blocks, 1502, 1504, 1506, a recommendation system 1508 makes recommendations based on the information of a customer and the availability of products, e.g., which can be included in a product list 1510. The system 1500 can provide customers with personalized recommendations that are likely to fit well and meet their preferences. In addition, the system 1500 can help retailers better manage their stock and inventory by providing insights into which products are popular among different customer segments. By analyzing customer data such as age range, gender, and body shape, the system 1500 can provide recommendations for products that are likely to be in high demand, and retailers, e.g., clothing stores, fashion retailers, etc., can use this information to optimize their inventory and ensure they have enough stock to meet customer needs.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A system for rich human analysis, the system comprising:
a memory; and
one or more processors in communication with the memory configured to:
extract images from camera in a surveillance system;
feed the images to a person detection and tracking system that deciphers one or more human activity tasks;
estimate attributes of persons detected and tracked by the person detection and tracking system by a rich human analysis system to identify attributes in accordance with set criteria using a set of filters of deeper layers of convolutional layers of a feature extractor where the set of filters are divided into N groups trained on N corresponding tasks corresponding to task-specific heads such that one task is assigned to each group of the N groups and that each task loss updates only one subset of filters; and
identify one or more people that satisfy the attributes and the set criteria.

2. The system of claim 1, wherein the feature extractor generates a feature map from the images and task-specific heads output task predictions based on the feature map.

3. The system of claim 1, wherein, during training, each group of the N groups is only updated by its corresponding task gradients.

4. The system of claim 1, wherein. during training, each task learns its features without interference from other tasks.

5. The system of claim 1, wherein the set of filters are divided, during training, by backpropagation.

6. The system of claim 1, wherein the one or more human activity tasks include re-identification of a person having a trajectory that passes two or more cameras and attribute identification of the attributes of that person, such that the re-identification of the person and the attribute identification are concurrently performed.

7. The system of claim 1, wherein the one or more human activity tasks include pose estimation and attribute identification, and the pose estimation and the attribute identification are concurrently performed.

8. The system of claim 7, further comprising an action device responsive to the rich human analysis system wherein the action device adjusts a duration of a stop light in accordance with a pedestrian.

9. The system of claim 7, further comprising an action device responsive to the rich human analysis system wherein the action device alerts first responders in accordance with a pedestrian in need of assistance.

10. The system of claim 1, wherein the one or more human activity tasks include body segmentation and attribute identification, wherein the body segmentation and the attribute identification are concurrently performed.

11. The system of claim 10, further comprising a customized service system responsive to the rich human analysis system, wherein the customized service system recommends products based upon the body segmentation and the attribute identification.

12. A non-transitory computer-readable storage medium comprising a computer-readable program for rich human analysis, wherein the computer-readable program when executed on a computer causes the computer to:
extract images from camera in a surveillance system;
feed the images to a person detection and tracking system that deciphers one or more human activity tasks;
estimate attributes of persons detected and tracked by the person detection and tracking system by a rich human analysis system to identify attributes in accordance with set criteria using a set of filters of deeper layers of convolutional layers of a feature extractor where the set of filters are divided into N groups trained on N corresponding tasks corresponding to task-specific heads such that one task is assigned to each group of the N groups and that each task loss updates only one subset of filters; and
identify one or more people that satisfy the attributes and the set criteria.

13. The non-transitory computer-readable storage medium of claim 12, wherein the feature extractor generates a feature map from the images and task-specific heads output task predictions based on the feature map.

14. The non-transitory computer-readable storage medium of claim 12, wherein, during training, each group of the N groups is only updated by its corresponding task gradients and each task learns its features without interference from other tasks.

15. The non-transitory computer-readable storage medium of claim 12, wherein the set of filters are divided, during training, by backpropagation.

16. The non-transitory computer-readable storage medium of claim 12, wherein the one or more human activity tasks include re-identification of a person having a trajectory that passes two or more cameras and attribute identification of the attributes of that person, such that the re-identification of the person and the attribute identification are concurrently performed.

17. The non-transitory computer-readable storage medium of claim 12, wherein the one or more human activity tasks include pose estimation and attribute identification, and the pose estimation and the attribute identification are concurrently performed.

18. The non-transitory computer-readable storage medium of claim 17, further comprising an action device responsive to the rich human analysis system wherein the action device adjusts a duration of a stop light in accordance with a pedestrian.

19. The non-transitory computer-readable storage medium of claim 12, further comprising an action device responsive to the rich human analysis system wherein the action device alerts first responders in accordance with a pedestrian in need of assistance.

20. The non-transitory computer-readable storage medium of claim 19, wherein the one or more human activity tasks include body segmentation and attribute identification, wherein the body segmentation and the attribute identification are concurrently performed.
